(19) United States
(12) Patent Application Publication
(10) Pub. No.: US 2007/0139930 A1
(43) Pub. Date: Jun. 21, 2007

(54) METHOD AND SYSTEM FOR LED LIGHT THERAPY

(76) Inventor: Paul Spivak, Chesterland, OH (US)

Correspondence Address: DRIGGS, HOGG & FRY CO. L.P.A., 38500 CHARDON ROAD, DEPT. DLBH, WILLOUGBY HILLS, OH, 44094, US

(21) Appl. No.: 11/612,918

(22) Filed: Dec. 19, 2006

Related U.S. Application Data
(60) Provisional application No. 60/751,754, filed on Dec. 19, 2005.

(51) Int. Cl. F21V 29/00

(52) U.S. Cl. 362/294

(57) ABSTRACT

Methods and systems are provided for illuminating a subject with LEDs, comprising a substrate having a plurality of LEDs on one side facing a subject; a heat sink element attached to the substrate; and a heat sink fluid engaging the heat sink element; wherein heat generated by the operation of the LEDs is conducted by the substrate to the heat sink element to the heat sink, wherein the heat sink liquid dissipates the heat from the heat sink. The heat dissipation structure may comprise a heat sink fluid pumped through the heat sink. Matrix structures of LEDs are configured into generally semi-cylindrical shapes defined about a user's head and facial area, a user's first thigh area, or a user's first hand area. The heat sink removes operative heat from an area between the LEDs and a subject without forcibly moving air through the semi-cylindrical shape area.

### REFERENCE TO RELATED APPLICATION

This application is a continuation-in-part of a previous provisional application filed in the United States Patent and Trademark Office by Paul Spivak on Dec. 19, 2005, titled “METHOD AND SYSTEM FOR LED LIGHT THERAPY” and assigned Ser. No. 60/751,754, Confirmation No. 9793.

### FIELD OF THE INVENTION

The present invention relates to LED's light therapy applications and, more particularly, provides for heat dissipation structures for light emitting diodes (LED) and methods for matrices for application of LED light therapy.

### BACKGROUND OF THE INVENTION

A light emitting diode (LED) is a lighting device made of a semiconductor p-n junction diode. LED's have been found to be particularly suitable for “light therapy” applications. More specifically, skin will react beneficially through topically applied light waves, and hence photo modulation of cellular activity induced by illumination from LED's has been found to be successful for treating fine lines and wrinkles, cellulite and a variety of other dermatological problems such as acne, scarring, psoriasis, wound healing, etc.

However, in order to illunminate skin with a sufficient intensity of light, a large number of LED's are required in close proximity to the user's skin surfaces. This engenders a large amount of heat creation. What is needed is a way to effectively dissipate this heat and enable effective skin irradiation.

### SUMMARY OF THE INVENTION

It is an object to provide a heat dissipation structure for light emitting devices, thereby enabling matrices of LED's to operate and irradiate a subject's skin. In one aspect methods and systems are provided for illuminating a subject with a plurality of light emitting devices, comprising a substrate having a plurality of LED's on one side facing a subject; a heat sink element attached to the substrate; and a heat sink fluid engaging the heat sink element; wherein heat generated by the operation of the LED's is conducted by the substrate to the heat sink element to the heat sink, wherein the heat sink liquid dissipates the heat from the heat sink.

In one aspect the heat dissipation structure comprises a heat sink fluid pumped through the heat sink by a pump means. In another aspect a heat dissipation structure further comprises ventilation means for conveying a stream of air across the heat sink element. And still further a heat dissipation structure further comprises a refrigeration apparatus configured to cool the heat sink.

In another aspect a heat dissipation structure for a plurality of light emitting devices comprises a substrate having a plurality of LED's; a fluid-proof heat sink enclosure encompassing the substrate and the plurality of LED's; and a heat sink fluid encompassing the fluid-proof heat sink enclosure; wherein heat generated by the operation of the LED's is conducted by the fluid-proof heat sink enclosure to the heat sink liquid, wherein the heat sink liquid dissipates the heat.

Still further, an LED light projection system comprises a first matrix structure of LED's configured to emit light into a first generally semi-cylindrical shape defined about a void large enough to accommodate one of a user's head and facial area; a user's first thigh area; or a user's first hand area. A second matrix of LED's is configured to emit light onto a user's second body area simultaneously with the first matrix emitting light onto a user's first body area. And a fluid heat sink means is connected to the first matrix of LED's, wherein the fluid heat sink means removes operative heat from a semi-cylindrical shape area between the LEDs and a subject without forcibly moving air through the semi-cylindrical shape area. In another aspect the first matrix shape is configured to accommodate a user's head and facial area, the second matrix LED's are arrayed to define a second generally semi-cylindrical shape defined to accommodate one of a user's left thigh area or a user's left hand area, and a third matrix structure of LED's emit light into the third generally semi-cylindrical shape defined about a void large enough to accommodate one of a user's right thigh area or a user's right hand area; and wherein the fluid heat sink means is further connected to the second and third matrix structures, the fluid heat sink means removing operative heat from areas between the second and third matrix LEDs and a subject without forcibly moving air through the semi-cylindrical shape areas.

In one aspect LEDs are configured to emit red light, wherein in one aspect the LEDs are configured to emit light having a wavelength between about 630 nanometers and about 635 nanometers. In another aspect LEDs are configured to emit narrow band violet light having a wavelength between about 400 nanometers and about 420 nanometers. In an alternative example LEDs are configured to emit light having a wavelength of about 470 nanometers. And still further, LEDs are configured to emit narrow band red light having a wavelength of about 660 nanometers and infrared light having a wavelength of about 1450 nanometers.

### BRIEF DESCRIPTION OF THE DRAWINGS

These and other features of this invention will be more readily understood from the following detailed description of the various aspects of the invention taken in conjunction with the accompanying drawings in which:

FIG. 1a and 1b are perspective illustrations of a LED apparatus according to the present invention.

FIG. 2 is a side view of an array structure according to the present invention.

FIG. 3 is a plan view of a portion of an LED apparatus element according to the present invention.

FIG. 4 is a perspective view of a portion of a head area array structure according to the present invention in relation to a subject head area.

FIG. 5 illustrates another apparatus according to the present invention.

FIG. 6 illustrates another apparatus according to the present invention.

FIG. 7 is a side illustration of another LED substrate structure according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

According to the present invention methods, systems and apparatuses are provided that enable the use of light-emitting diode (LED) light therapy technology for a variety of health and medical applications. LED therapy is a non-invasive procedure that activates skin cells with pulses of non-thermal light energy. Photo modulation of cellular activity induced by illumination from light-emitting diodes (LED) has been found beneficial in skin therapy or treatment methods. Biological systems may exhibit an absorption spectrum which determines the wavelengths of light that will be absorbed to produce a given therapeutic effect. LED therapy systems include Skin-Rejuvenation Wrinkle Treatment, Skin-Refining Acne Treatment, Skin-Smoothing Cellulite Treatment, Skin-Refining Psoriasis Treatment and Advanced LED Light Therapy Treatment for Seasonal Affective Disorder systems (each of are trademarks of Light Therapy Systems in the United States and/or other countries).

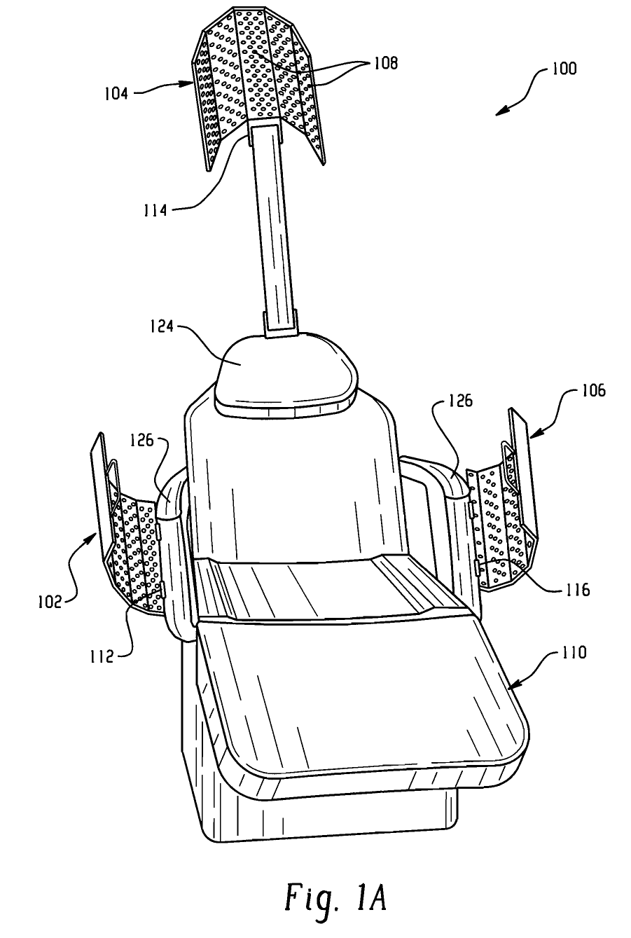

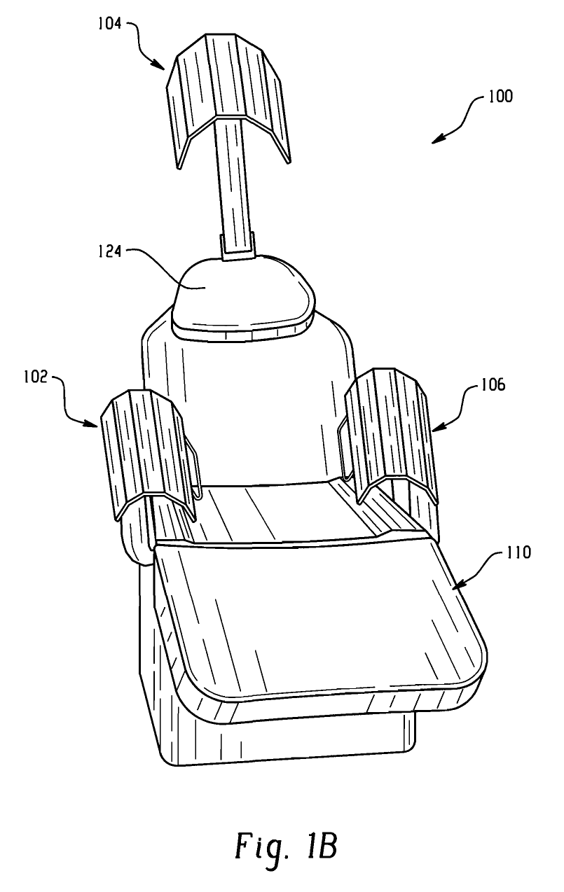

Referring now to FIGS. 1a and 1b and 2, a light therapy apparatus 100 according to the present invention is illustrated. Matrix array structures 102, 104, 106 of pluralities of LED's 108 are provided for photo light therapy, configured in the present embodiment to impact the face, neck and hand regions of a subject positioned upon the chair structure 110. More particularly, FIG. 1a shows each of the matrix arrays 102, 104, 106 pivoted about hinge means 112, 114, 116, respectively, into an open configuration. A subject may then sit or recline on the chair 110 with the back of her head on the headrest 124 and each arm resting on one of the armrests 112. The matrix arrays 102, 104, 106 are then pivoted back about their respective hinge means 112, 114, 116 into the closed configuration shown in FIG. 1b, and the subject may be irradiated with light from each of the matrix arrays 102, 104, 106.

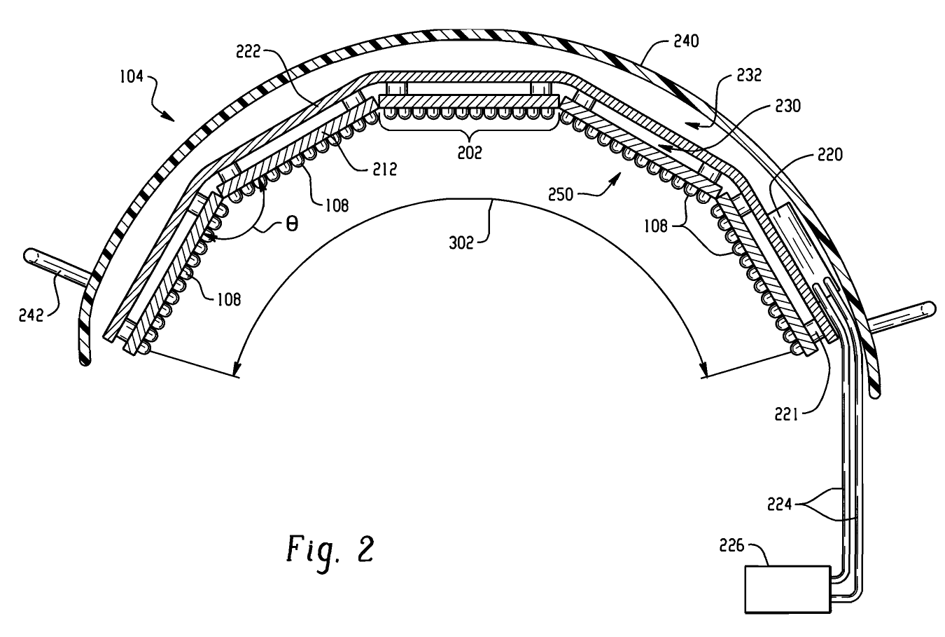

Each array structure according to the present invention comprises one or more substrates, each comprising a plurality of LEDs 108. More particularly, FIG. 2 is a side view of the head region array structure 104. The array structure 104 is formed with five adjacent planar substrates 212 each having pluralities 202 of LED's 108, each substrate 212 positioned at one or more angles θ with respect to an adjacent substrate 212. FIG. 3 presents a plan view of portions of the substrates 212, wherein each substrate LED array 202 presents alternating rows 204, 206, 208 of LED's 108, with repeating alternating patterns of evenly spaced LED's 108 in each of first pattern rows 204-208 and second pattern rows 206-210, presenting the composite interdigitated repeating pattern 202 illustrated. However, it will be appreciated that this is only one example of an LED array pattern, and that other LED 108 patterns may be practiced according to the present invention.

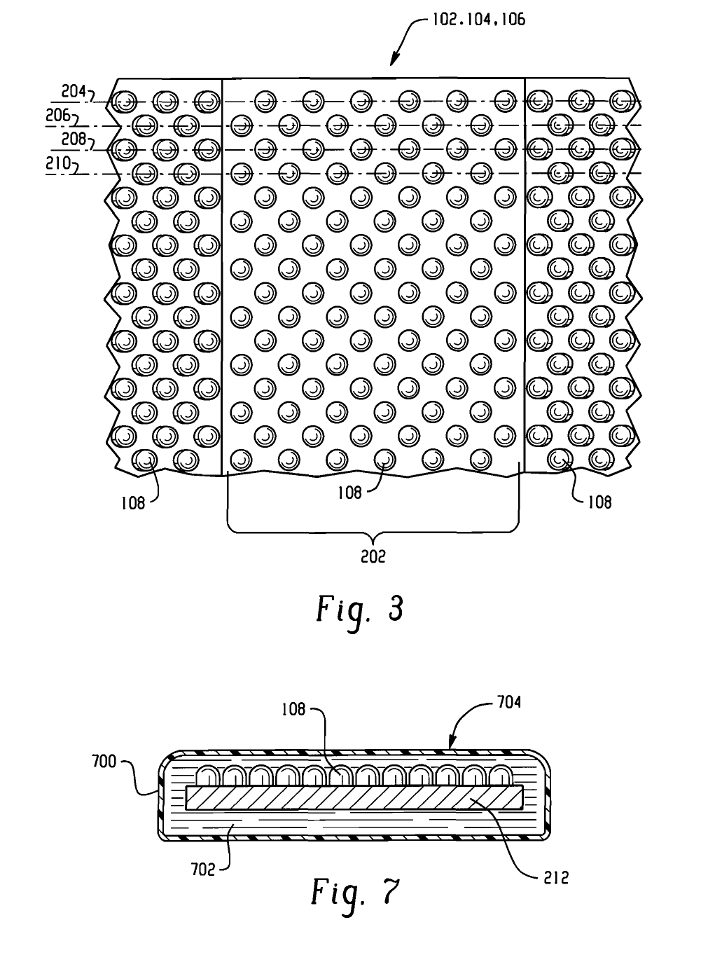

FIG. 4 illustrates a perspective view of a portion of the head area array structure 106 in relation to a subject head area positioned on the chair 110 for treatment as described above. Thus as illustrated in FIGS. 2 and 4, the five substrates 212 together define a composite generally semi-cylindrical LED array configuration 302, which may be selected to conform to a curved profile SH presented by a subject's head and neck area. One advantage of the semi-cylindrical LED array configuration 302 is that by generally conforming to the curved profile SH it enables placement of each of the LED's 108 (or pluralities thereof within a common distance or range of distances 304 from subject curved profile SH skin surfaces. As the intensity of light illumination from an LED 108 drops off in proportion to an increased distance 304 from the subject skin surface profile SH, this arrangement enables a constant or narrow range or intensity levels from each of the LED's 108 relative to subject skin surfaces.

Photo light therapy has been shown to smooth skin and reduce lines and wrinkles by penetrating deep beneath the skin surface and provide photon energy to the skin cells directly, thus increasing collagen and elastin production. As the face, neck and hand regions are generally of primary concern with regard to wrinkles and other aging appearance indicators, the present apparatus 100 is configured to provide the LED matrix arrays 104, 106, 108 to illuminate these regions.

Laboratory studies have shown that skin cells grow 150-200 percent faster when exposed to certain LED light wavelengths. And research has shown LED red and infrared light delivers powerful therapeutic benefits to living tissue. Both visible red and infrared light has been shown to affect at least 24 different positive changes at a deep level. Thus in one embodiment the LED's 108 project visible red light, at wavelengths from 630-660 nanometers, preferably arrayed at LED-to-skin surface distances 304 and with sufficient intensities selected to penetrate skin tissue to a depth of 8-10 mm.

More particularly, LED light is beneficial in treating problems close to the skin's surface such as wounds, cuts, and scars. Skin layers, because of their high blood and water content, absorb red light very readily and deliver enough energy to stimulate a response from the body to heal itself. LED photons must be absorbed to produce a biological response. The visible red and infrared portions of the spectrum have been shown to be highly absorbent and produce unique restorative effects in living tissues. It is thought that light photons are absorbed by the skin and underlying tissue, which trigger biological changes within the body in a process known as photo-biomodulation. In one embodiment pluralities of the LED's 108 are configured to illuminate subject skin with pulses of low-level, non-thermal light energy in a non-invasive procedure that activates skin cells to ameliorate the appearance of aging, fine lines, wrinkles, enlarged pores, crow's feet wrinkles and mottled skin tone. In one example, the LED 108 red light waves have a wavelength of about 633 nanometers; another embodiment emits red light waves within a narrow wavelength band (between about 630 nm and about 635 nm). However, other wavelengths may be found appropriate and practiced.

In another advantage the three separate LED matrices 102, 104, 106 provide for simultaneous skin therapy treatment of a subject's face and hands. This allows for efficient and optionally simultaneous skin therapy over larger areas of a user's skin than taught by other illumination systems, providing advantages in time and/or energy efficiencies, and in particular over prior art methods and systems which provide therapy light only upon facial areas.

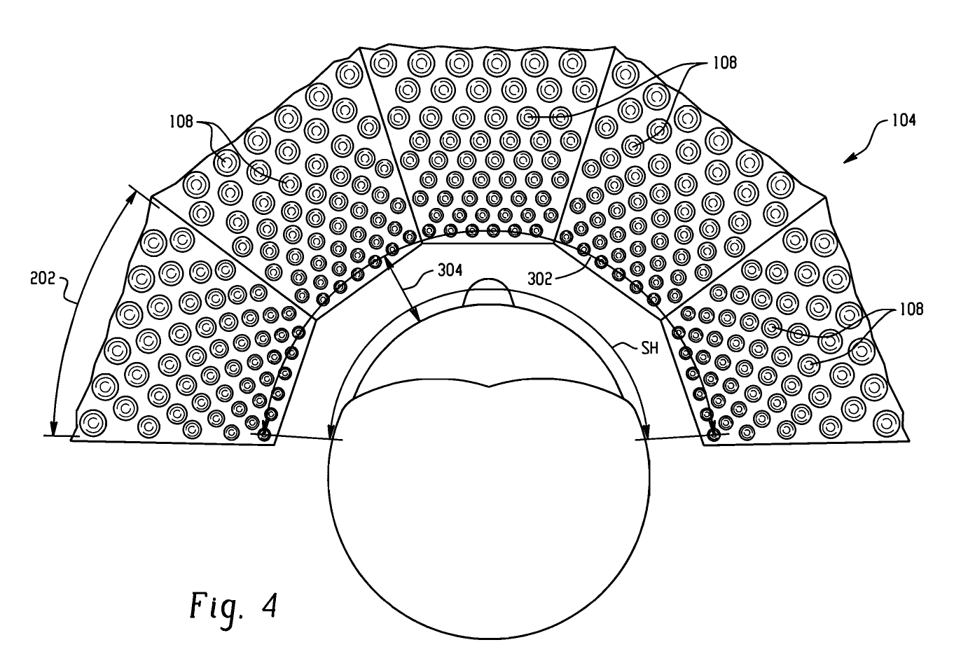

Different LED array structures may also be practiced according to the present invention. For example, FIG. 5 illustrates another LED apparatus 400 according to the present invention. The LED matrix array structure 104 is provided for illumination of a subject face and neck in a chair structure 410, wherein the chair 410 also defines a back support aperture 402 comprising planar LED pluralities 404 configured to illuminate a subject's back. Thus the face and back areas of a subject sitting or reclining on the chair 410 may be irradiated with light from each of the matrix arrays 104 and 404.

In one example the apparatuses 100 and 400 may be configured to administer light therapy to a subject in response to acne skin conditions. More particularly, at puberty the oil glands of a subject's skin start producing an oily material called sebum, which lubricates the skin. Sometimes the wall of the oil gland breaks and spills the sebum within the skin, causing redness, swelling, and pus—in other words, a pimple. Plugged oil glands may form blackheads and whiteheads. There is also a type of bacteria that normally lives on the skin called Propionibacterium acnes (P. acnes). These bacteria live on the sebum produced by the skin's oil glands. Sometimes, this bacterium multiplies, resulting in inflammation and acne. Acne may also become worse when one is under stress, and certain ingredients in cosmetics can aggravate acne.

It is known that visual improvements in skin experiencing acne can be achieved with visible light therapy, and in particular strong violet light generated by purpose-built fluorescent lighting, dichroic bulbs, LEDs or lasers. The mechanism appears to be that porphyrins produced within P. acnes generate free radicals when irradiated by blue light, wherein the free radicals ultimately kill the bacteria. Such light therapy treatment apparently works even better if used with violet visible light (660 nanometer), in one example resulting in a 76% reduction of lesions after three months of daily treatment for 80% of the patients, wherein overall clearance was similar to or better than treatment with topical agents such as benzoyl peroxide. Thus in one example of the apparatus 400 the arrays 104,404 are configured to treat two areas of skin most frequently affected by acne bacteria: the face and the back. In one embodiment the matrix arrays 104 and 404 comprise pluralities of LEDs 108 configured to irradiate a subject with narrow band violet light measuring between 405 nm and 420 nm.

Alternate embodiments of LED arrays may utilize LED's that emit light of different wavelengths. For example, there are a number of different theories on the question of which LED wave length is most effective in the treatment of acne: some studies have shown that a wave length of 400 or 405 is better than 410 or 415. Thus in some embodiments of the present invention different LED wave lengths may be provided, and sometimes within the same light panel substrate 212. Referring again to FIG. 3, For example, a substrate 212 have the structure as shown in FIG. 2, but with alternating first rows 204 of 400 nm LEDs, second rows 206 of 410 nm LEDs and third rows 208 with 415 nm LED's, and configured to selectively illuminate one or two or more of the three rows 204,206,208. This provides advantages in enabling customized subject light irradiation configurations.

Seasonal Affective Disorder (SAD) may also be treated with light therapy according to the present invention. SAD occurs generally during winter months, and appears to vary according to latitude and subject age and gender. Thus LED substrates 212 may be configured to comprise LEDs that generate narrow band blue light measuring at 470 nm, which has been clinically proven to help reduce signs of SAD depression.

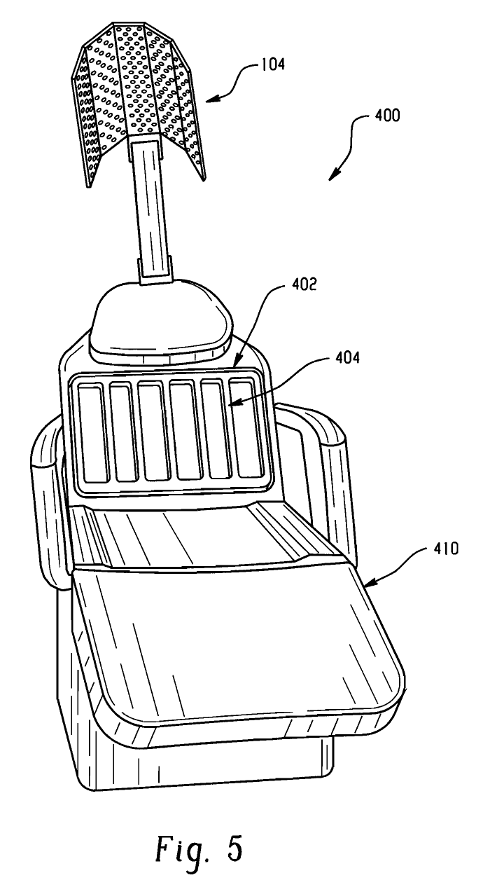

FIG. 6 illustrates another light therapy apparatus 500 according to the present invention, more particularly configured to provide cellulite light therapy. Cellulite refers to fat deposits under the skin, often characterized by a dimpled or orange-peel appearance caused by structural changes underneath the skin's top layer. One common explanation for cellulite has to do with the structure of the fat layer below the skin. In women, vertical fibers of connective tissue segregate fat into columnar pockets. Cellulite develops when small blood vessels in the fat layer become damaged, perhaps due to inflammation. The circulation of blood and lymph slows, and fluid accumulates. Although the layer of fat swells, the fat tissue remains tethered to connective tissue, creating puckers. The apparatus 500 comprises LED substrates 212 configured to treat two areas of skin most frequently affected by cellulite: the thighs and the buttocks. Thus a buttocks support aperture 502 comprising large planar LED substrates 212 is configured to illuminate a subject's buttocks and adjacent area, and two curvilinear LED arrays 506 comprising one or substrates 212 each are configured to illuminate each of a subject's thighs, in one example with narrow band red and infrared light measuring at 660 nm and 1450 nm from the matrix arrays 504 and 506.

In another aspect the present invention may also be used in light therapy applications psoriasis, a chronic disease of the skin marked by red patches covered with white scales. More particularly, the LED substrates 212 may be configured with ultraviolet (UV) light LEDs 108, which is believed to treat psoriasis by killing abnormal skin cells, altering skin immune reactions, or slowing psoriasis patch reproduction. Thus an apparatus, for example the chairs 100,400,500 described above (though other configurations may be practiced) may be configured to provide UVB treatment, Psoralen UVA (PUVA) treatment which combines UVA exposure with a photosensitizing agent, narrow-band UVB, or other appropriate light therapy applications.

One advantage of the light therapy apparatus 100 is that it provides for improved methods and systems for cooling the LEDs 108, associated structures and regions nearby. Prior art methods and systems generally use forced air-based means to keep lighting structures and adjacent areas cool during operations, both for the safety and efficient operation of the illuminating equipment and for the comfort of a subject being irradiated thereby. However, force-air cooling means are noisy, and generally require a large volume of air to be blown over the light emitting devices and adjacent to the subject skin areas being irradiated, which may significantly reduce the comfort of the subject during light therapy.

In contrast, the present invention provides for liquid-cooled heat dissipation structures. Referring again to FIG. 2, in one example each of the substrates 212 is connected to an aluminum body element 222 through heat conductive connection means 221, such as for example aluminum studs 221. A heat sink element 220 is attached to the aluminum body element 222. An outer cover element 240 is also provided with handles 242 for moving or otherwise handling the array structure assembly 104.

The heat generated by the operation of the LED's 108 thus is conducted by the LED substrates 212 through the heat conductive connection means 221 to the aluminum body element 222, and from the aluminum body element 222 to the heat sink 220, which dissipates the heat by liquid cooling through fluid pumped through hose means 224 by a pumping/cooling means 226. Accordingly, it is preferred that the LED substrate 212 is made of a thermally conductive material for transfer by conduction of heat to the heat sink. Substrate examples include structures incorporating aluminum and copper materials. The fluid pumped through the hose means 224 and heat sink 220 may be any appropriate liquid. Examples include glycerin, liquid silicone, water, deionized water, anhydrous ammonia, Freon, and oil, although one skilled in the art may use other fluids.

Inner air gap regions 230 between the substrates 212 and the aluminum body element 222, and outer air gap regions 232 between the aluminum body element 222 and the outer array cover 240 may also heat up as a result of illumination of the LEDs 108, and the aluminum body element 222 will act a s heat sink to draw heat into the aluminum body element 222 as it is cooled by operation of the heat sink 220. Moreover, as the heat sink 220 draws heat away from the array structure 104 through the liquid pumping actions of the hose means 224 and pumping/cooling means 226, the LED substrate surface areas 250 facing a subject will also be cooled/kept cool, thus effectively enabling comfortable temperature environments for a subject receiving light therapy without requiring forced air means to blow air across or upon the subject. As cool air being blown across subject skin may make the subject uncomfortable, or even chill some subjects (in particular, elderly subjects), the present invention thus provides advantages over other systems that rely on force-air cooling of the lighting areas.

In another aspect the amount of heat drawn out of the array structure 104 elements and adjacent air regions 230,232,250 may be controlled by controlling the pumping/cooling means 226. Hence if general atmospheric environments (i.e., the temperature of a room or general environment containing a light therapy apparatus) or personal subject preferences dictate warmer or cooler operating temperatures, the pumping/cooling means 226 may be adjusted to remove just enough heat to produce the desired operation heat characteristics.

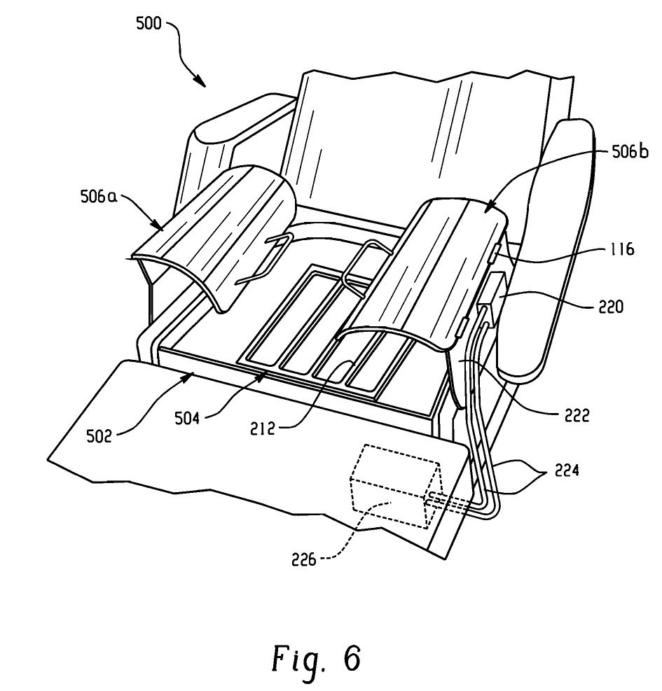

In one alternative embodiment the heat sink 220 may be an aluminum tape structure, an end portion of which (not shown) is cooled to thereby remove heat. FIG. 7 illustrates another heat sink embodiment wherein the substrate 212 is enclosed within a fluid-proof heat sink enclosure 700 encompassing the substrate 212 and the plurality of LED's 108, and wherein a heat sink fluid 702 encompassing the substrate 212 and the plurality of LED's 108 functions to dissipate heat. In one embodiment, the fluid-proof heat sink enclosure 700 is a plastic material, with a light transparent top surface 704 configured to emit LED light of a desired wave length and/or intensity.

The heat sink 220 may also comprise other heat removal media or systems. For example, air may be directed across the heat sink 220 for absorbing heat and removing it from the heat sink 220, wherein power fans or ventilation systems may also be provided to improve air cooling properties. Alternatively, well known air conditioning or refrigeration systems may be adapted to pull heat from the heat sink element.

The present invention is not limited to the embodiments described above, but may be changed and modified without departing from the scope and spirit of the invention. While preferred embodiments of the invention have been described herein, variations in the design may be made, and such variations may be apparent to those skilled in the art of LED and skin therapy systems, as well as to those skilled in other arts. The materials identified above are by no means the only materials suitable for the manufacture of the embodiments, and substitute materials will be readily apparent to one skilled in the art. The scope of the invention, therefore, is only to be limited by the following claims.

What is claimed is:

1. A system for illuminating a subject with a plurality of light emitting devices, comprising:
a substrate having a plurality of LED's on one side facing a subject;
a heat sink element attached to the substrate; and
a heat sink fluid engaging the heat sink element;
wherein heat generated by the operation of the LED's is conducted by the substrate to the heat sink element to the heat sink, wherein the heat sink liquid dissipates the heat from the heat sink.

2. The heat dissipation structure of claim 1 wherein the heat sink fluid is pumped through the heat sink by a pump means.

3. The heat dissipation structure of claim 2, further comprising ventilation means for conveying a stream of air across the heat sink element.

4. The heat dissipation structure of claim 2 further comprising a refrigeration apparatus configured to cool the heat sink.

5. A heat dissipation structure for a plurality of light emitting devices comprising:
a substrate having a plurality of LED's;
a fluid-proof heat sink enclosure encompassing the substrate and the plurality of LED's; and
a heat sink fluid encompassing the fluid-proof heat sink enclosure;
wherein heat generated by the operation of the LED's is conducted by the fluid-proof heat sink enclosure to the heat sink liquid, wherein the heat sink liquid dissipates the heat.

6. An LED light projection system comprising:
a first matrix structure of LED's configured to emit light, the first matrix LED's arrayed to define a first generally semi-cylindrical shape wherein each LED emits light into the first generally semi-cylindrical shape, the first generally semi-cylindrical shape defined about a void large enough to accommodate one of
a user's head and facial area;
a user's first thigh area; or
a user's first hand area;
′a second matrix of LED's configured to emit light onto a user's second body area simultaneously with the first matrix emitting light onto a user's first body area; and
a fluid heat sink means connected to the first matrix of LED's, wherein the fluid heat sink means removes operative heat from a semi-cylindrical shape area between the LEDs and a subject without forcibly moving air through the semi-cylindrical shape area.

7. The system of claim 6, wherein the first matrix semi-cylindrical shape is configured to accommodate a user's head and facial area;
wherein the second matrix structure LED's are arrayed to define a second generally semi-cylindrical shape wherein each LED emits light into the second generally semi-cylindrical shape, the second generally semi-cylindrical shape defined about a void large enough to accommodate one of a user's left thigh area or a user's left hand area;
the system further comprising a third matrix structure of LED's, the third matrix structure LED's arrayed to define a third generally semi-cylindrical shape wherein each LED emits light into the third generally semi-cylindrical shape, the third generally semi-cylindrical shape defined about a void large enough to accommodate one of a user's right thigh area or a user's right hand area; and
wherein the fluid heat sink means is further connected to the second and third matrix structures, wherein the fluid heat sink means removes operative heat from semi-cylindrical shape areas between the second and third matrix structure LEDs and a subject without forcibly moving air through the semi-cylindrical shape areas.

8. The system of claim 7 wherein a plurality of the LEDs is configured to emit red light.

9. The system of claim 8 wherein the plurality is configured to emit light having a wavelength between about 630 nanometers and about 635 nanometers.

10. The system of claim 6 wherein a plurality of the LEDs is configured to emit narrow band violet light having a wavelength between about 400 nanometers and about 420 nanometers.

11. The system of claim 6 wherein a plurality of the LEDs is configured to emit light having a wavelength of about 470 nanometers.

12. The system of claim 6 wherein a plurality of the LEDs is configured to emit narrow band red light having a wavelength of about 660 nanometers and infrared light having a wavelength of about 1450 nanometers.
